(19) United States
(12) Patent Application Publication
(10) Pub. No.: US 2015/0186802 A1
(43) Pub. Date: Jul. 2, 2015

(54) Systems and Methods for Managing Travel

(71) Applicant: MASTERCARD INTERNATIONAL INCORPORATED, Purchase, NY (US)

(72) Inventor: Daniel Hulbert, Troy, MO (US)

(73) Assignee: MASTERCARD INTERNATIONAL INCORPORATED, Purchase, NY (US)

(21) Appl. No.: 14/144,947

(22) Filed: Dec. 31, 2013

(51) Int. Cl. G06Q 10/02; G06Q 50/26

(52) U.S. Cl. CPC G06Q 10/02; G06Q 50/265

(57) ABSTRACT

Systems, methods and devices for use in managing travel are disclosed. One exemplary method includes assigning a risk value to a request for travel to a destination during a travel period and compiling a travel plan based on the assigned risk value, the travel plan defining a first predetermined check-in time. The exemplary methods further includes sending a first check-in communication, via a network interface, to a traveler at the first predetermined check-in time, designating the first check-in communication completed, when the first check-in communication is acknowledged by the traveler within a time interval of the first predetermined check-in time, and generating a warning event, when the first check-in communication is not acknowledged by the traveler within the time interval after the first predetermined check-in time.

### FIELD

The present disclosure generally relates to systems and methods for managing travel.

### BACKGROUND

This section provides background information related to the present disclosure which is not necessarily prior art.

Domestic and international business activity is important to many companies. And, travel within this or different countries is often necessary to promote the business activity. However, as can be appreciated, numerous risks are associated with such travel, such as risks associated with simply flying to the different countries and risks associated with traveler presence in the different countries.

### DRAWINGS

The drawings described herein are for illustrative purposes only of selected embodiments and not all possible implementations, and are not intended to limit the scope of the present disclosure.

FIG. 1 shows an exemplary system for use in managing travel;

FIG. 2 is a block diagram of an exemplary computing device, suitable for use in the system of FIG. 1;

FIG. 3 is a flowchart of an exemplary method for managing travel, which can be implemented via the system of FIG. 1;

FIGS. 4A-4C are portions of an exemplary travel request page for use in the system of FIG. 1;

FIG. 5 is an exemplary status page for use in viewing pending check-in communications for multiple travelers in the system of FIG. 1; and

FIG. 6 is the exemplary status page of FIG. 5, with a warning event for one of the travelers resulting from a missed check-in communication.

Corresponding reference numerals indicate corresponding parts throughout the several views of the drawings.

### DETAILED DESCRIPTION

Certain risks are involved in travel, including travel in foreign countries, and especially travel in countries with unstable governments, countries involved in conflicts, and/or countries in which certain travelers are targeted by criminals or terrorists. This particular travel may be considered high-risk. Disclosed herein are systems and methods for managing such travel (e.g., segments of such travel, and particularly high-risk travel segments of such travel, etc.) and for implementing safety measures to account for traveler safety during the travel. For example, check-in communications may be provided to confirm the safety of travelers at different predetermined check-in times during their travel. In response, a traveler may be required to acknowledge the check-in communications, through a portable communication device, within a certain time interval of the predetermined check-in times, thereby permitting an organizer of the travel, such as an employer, to confirm or account for the safety of the traveler.

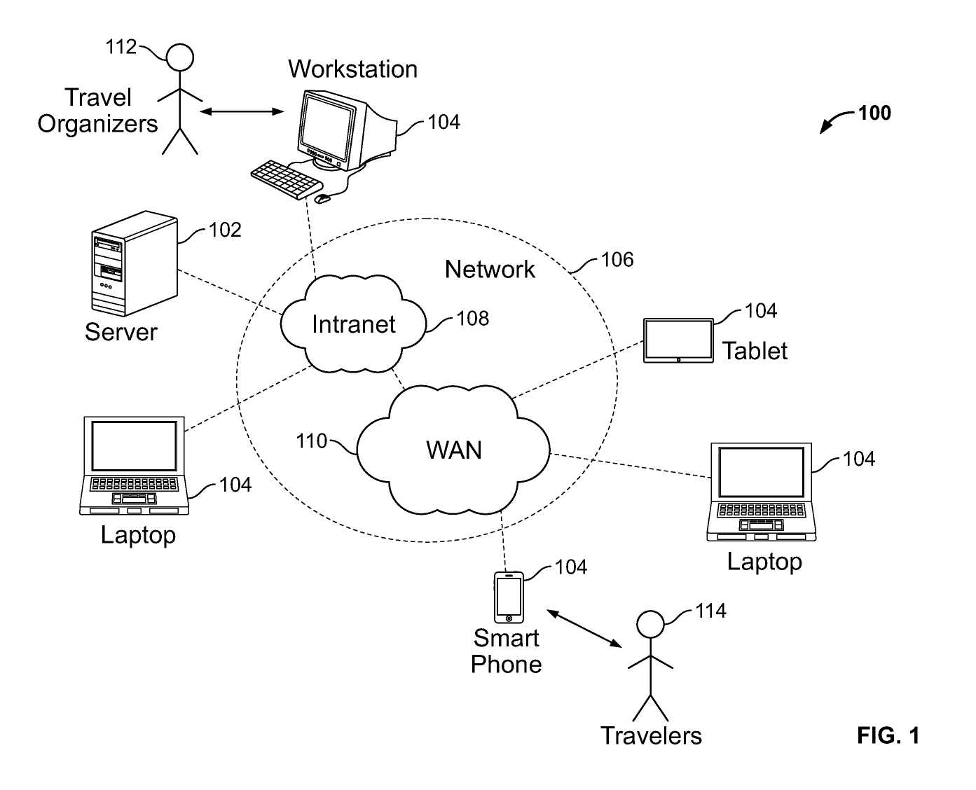

With reference now to the drawings, FIG. 1 illustrates an exemplary system for use in managing travel, and in which one or more aspects described herein may be implemented. It should be appreciated that although in the illustrated embodiment, elements of the system 100 are presented in one arrangement, other embodiments may include the same or different elements arranged otherwise, for example, depending on an organizer of the travel, travel destinations, number of travelers (or groups of travelers), and/or travel management requirements, etc.

As shown in FIG. 1, the system 100 includes a server 102 and multiple communication devices, each indicated at reference number 104, and each coupled to the server 102, via a network 106. The system 100 may be accessed and/or utilized by at least two different types of users: traveler organizers 112 and travelers 114, for example. The travel organizers 112 include employers, government agencies, or other entities, which are involved in planning, coordinating, and/or directing person(s) or group(s) of persons to travel to one or more destinations. The destinations may be foreign or domestic, and include countries with a variety of risk levels, as further described below. The travelers 114 are person(s) or group(s) of persons who travel to the one or more destinations. In the system 100, a travel organizer 112 utilizes the server 102, either directly or indirectly through a computing device 104, such as, for example, a workstation, to interface the travel management systems and methods described herein. Conversely, the travelers 114, who are often in transit, utilize communication devices 104, such as, for example, portable communication devices, to interface the travel management systems and methods described herein. In at least one embodiment, however, a travel organizer may utilize a portable communication device, and a traveler may utilize the server 102, directly or through the communication device 104.

One or more of the communication devices 104 may include, without limitation, a tablet computer (e.g., an iPad™, a Samsung Galaxy™, etc.), a desktop computer, a laptop computer, a workstation computer, a personal computer, a handheld computer or a communication device (e.g., a netbook, a specialized reservation device, etc.), a smart phone (e.g., an iPhone™, a BlackBerry™, a HTC™ phone, etc.), a pager, the like, or combinations thereof. Similarly, any suitable server 102, as known to those skilled in the art, may be employed. In addition, the network 106 may include, without limitation, a local private intranet, a local area network (LAN), a wide area private network, a wide area public network (e.g., the Internet, etc.), a mobile network, a virtual network, and/or another suitable network capable of supporting communication between the server 102 and one or more of the communication devices 104, and combinations thereof. The network 106 includes, in this particular embodiment, a wide area public network (WAN) 110 (such as, the Internet, etc.), and a private intranet 108 accessible to, for example, the travel organizer or traveler to submit new travel requests and/or manage existing travel requests and/or travel plans.

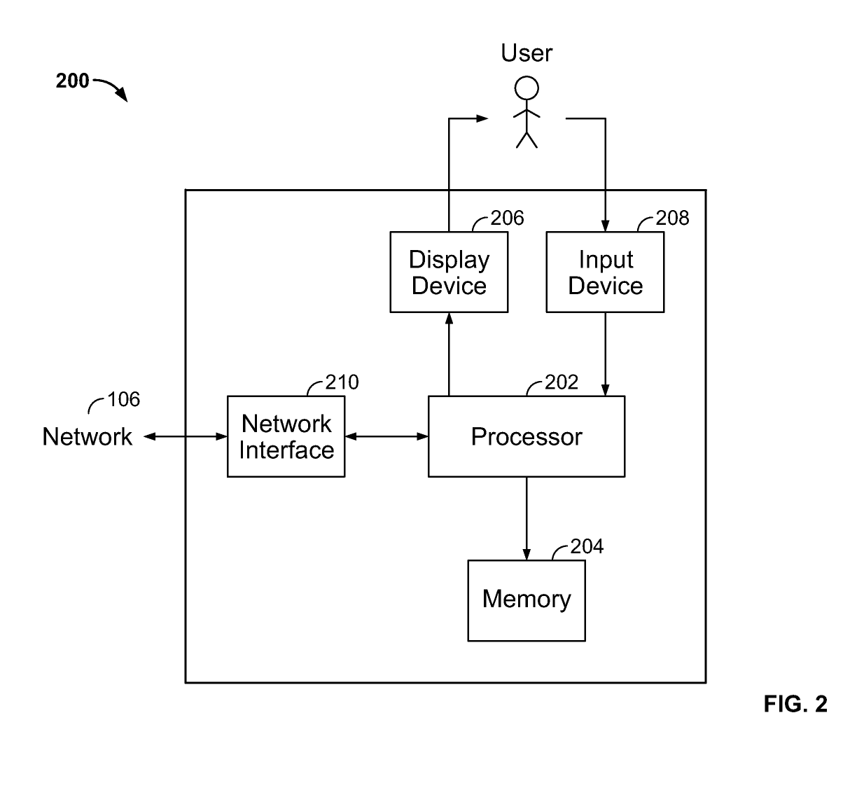

FIG. 2 illustrates an exemplary computing device 200. In the exemplary embodiment of FIG. 1, each of the server 102 and the communication devices 104 is a computing device, consistent with computing device 200. The system 100, and its components, however, should not be considered to be limited to the computing device 200, as different computing devices and/or arrangements of computing devices may be used. In various embodiments, the server 102, for example, includes multiple computing devices located in close proximity, or distributed over a geographic region.

Referring again to FIG. 2, the exemplary computing device 200 includes a memory 204 and a processor 202 that is coupled to memory 204. Processor 202 may include one or more processing units (e.g., in a multi-core configuration, etc.). Computing device 200 is programmable to perform one or more operations described herein by programming memory 204 and/or processor 202. Processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of the term processor.

Memory 204, as described herein, is one or more devices that enable information, such as executable instructions and/or other data, to be stored and retrieved. Memory 204 may include one or more computer-readable media, such as, without limitation, dynamic random access memory (DRAM), static random access memory (SRAM), a solid state disk, and/or a hard disk. Memory 204 may be configured to store, without limitation, multiple travel requests, traveler profiles, travel plans, historical travel information per traveler or group of travelers, and/or any other type of data suitable for use as described herein.

In the exemplary embodiment, computing device 200 includes a display device 206 that is coupled to processor 202. Display device 206 outputs to a user by, for example, displaying and/or otherwise outputting information such as, but not limited to, pages, interfaces, warnings, events, traveler profiles, travel plans, and/or any other type of data. For example, display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices.

In the exemplary embodiment, computing device 200 further includes an input device 208 that receives input from the user, such as a travel organizer or traveler. For example, input device 208 may be configured to receive inputs, acknowledgements, selections, and/or any other type of inputs from a user. In the exemplary embodiment, input device 208 is coupled to processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet or similar device, functions as both display device 206 and input device 208.

In the exemplary embodiment, computing device 200 also includes one or more network interface devices 210 coupled to processor 202. Network interface device 210 may include, without limitation, a wired network adapter, a wireless network adapter, a mobile telecommunications adapter, or other device capable of communicating to one or more different networks, including the network 106. In at least one embodiment, computing device 200 includes processor 202 and one or more network interface devices 210 incorporated into or with processor 202.

In further embodiments, computer-executable instructions are stored on non-transitory memory 204 for execution by processor 202 to perform one or more of the functions described herein. These instructions may be embodied in a variety of different physical or tangible computer-readable media, such as memory 204 or other non-transitory memory, such as, without limitation, a flash drive, CD-ROM, thumb drive, floppy disk, etc. Computer-readable media may be selectively insertable from a computing device to permit access to and/or execution by processor 202. In one example, computer-readable media includes a separate optical or magnetic disc that is inserted or placed into an input device 208 associated with memory 204 and/or processor 202. In some instances, the computer-readable media may not be removable.

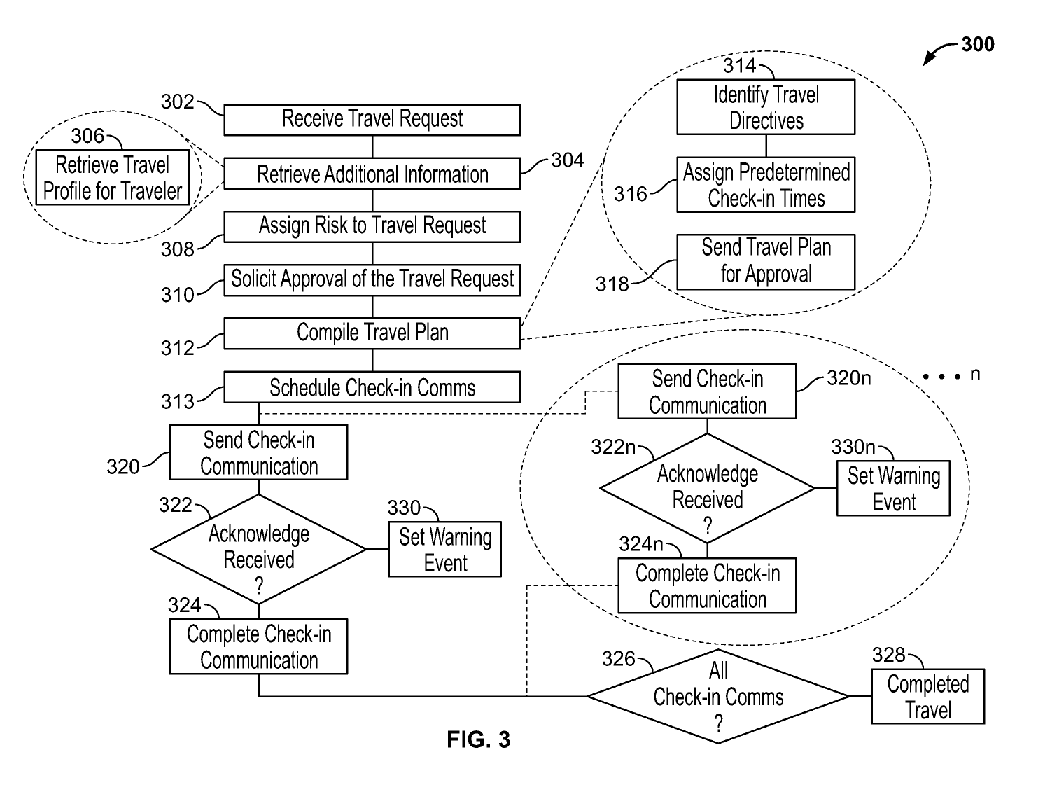

In the exemplary embodiment, the server 102 is configured to, among other things, receive travel requests, compile travel plans based on the travel requests, send check-in communications to travelers, set warning events under certain conditions, send reminder communications before and/or after check-in communications, etc. Specific configurations of the exemplary server 102 and/or communication devices 104 are further described below with reference to the exemplary method 300 of FIG. 3. It should be appreciated, however, that the methods described herein are not limited to the exemplary system 100, or the computing device 200, but may be implemented in a variety of different systems and/or computing devices. Likewise, the systems and the computing devices described herein should not be understood to be limited to the exemplary method 300 of FIG. 3.

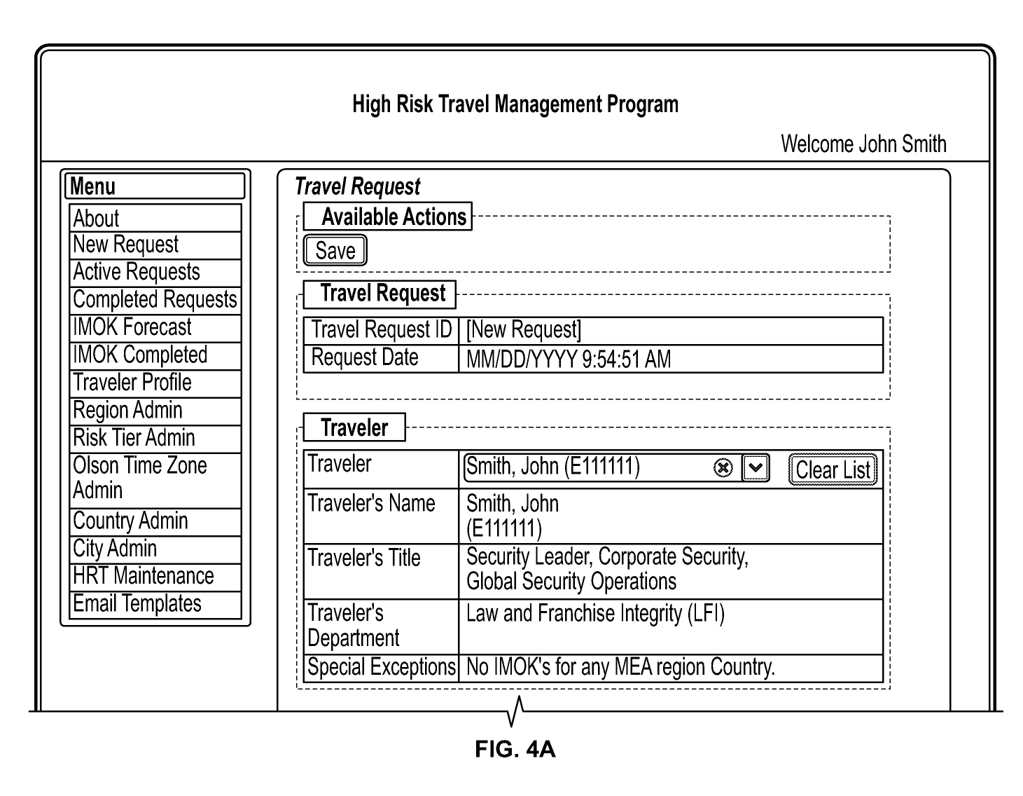

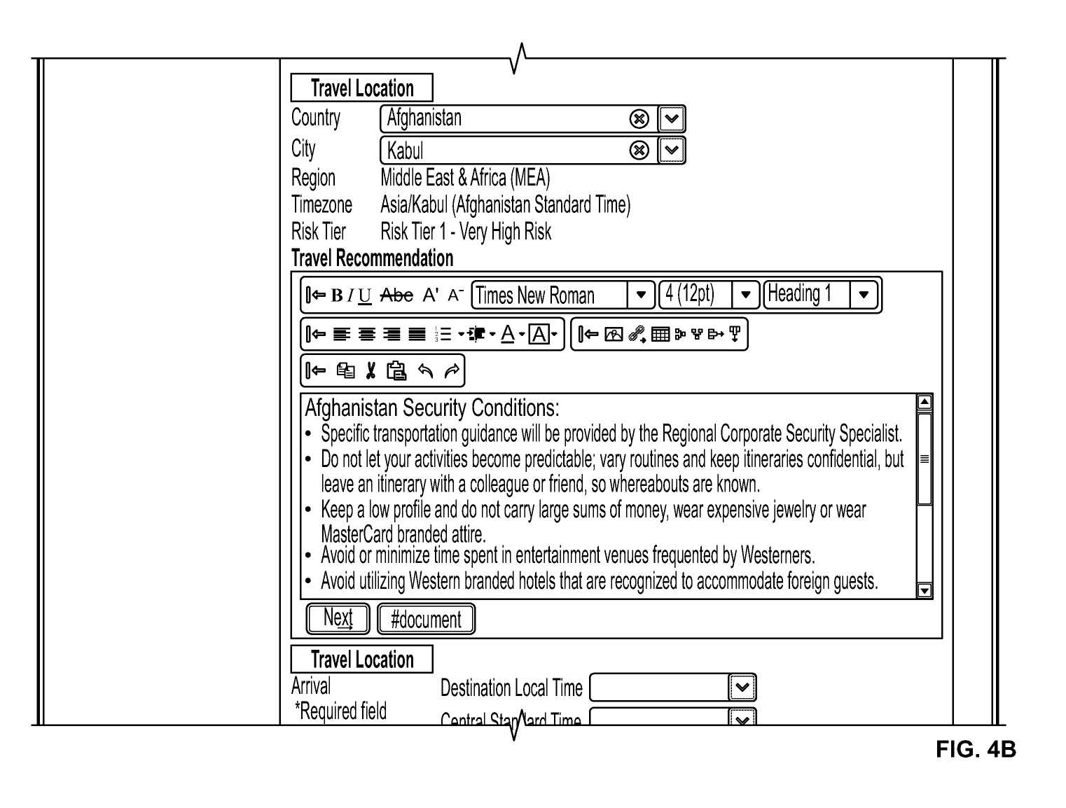

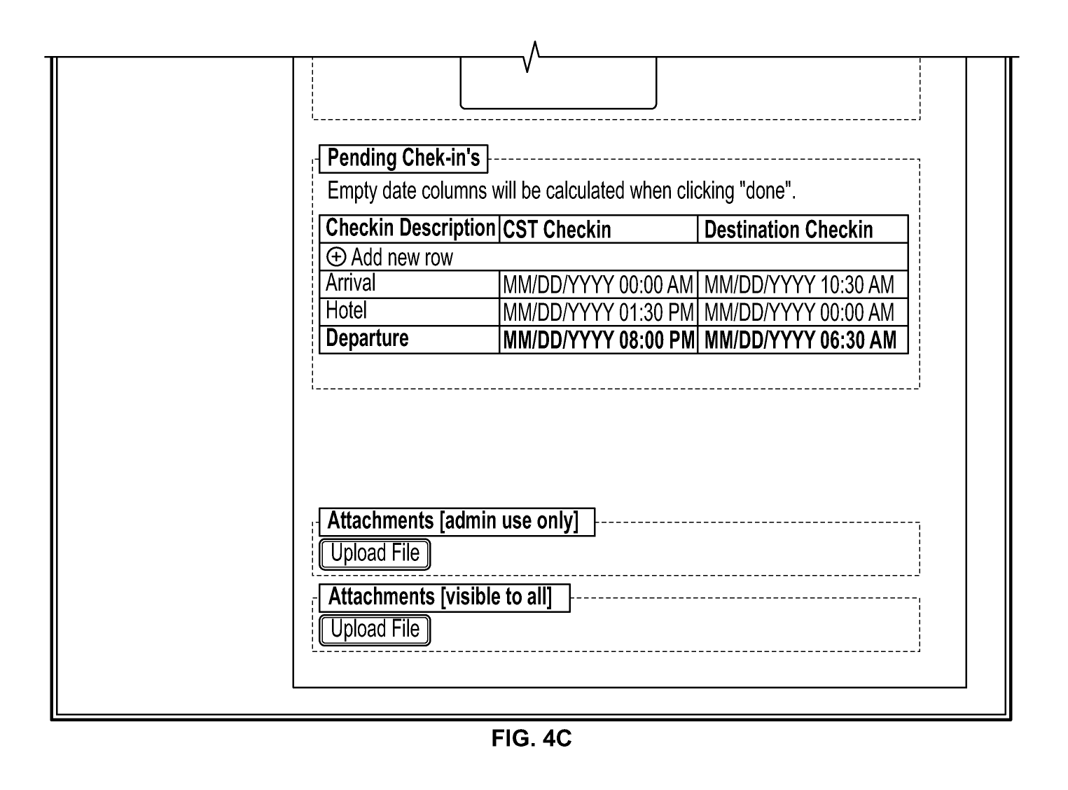

In addition to the exemplary method 300, exemplary pages are illustrated in FIGS. 4-6 as further description of the methods and systems herein. The exemplary pages are webpages, which are transmitted from the server 102 to a communication device 104, in one or more forms, including as packetized data, etc., and displayed to a user via one or more of the communication devices 104, at display device 206, to present information to the user. Additionally, the pages displayed at one or more of the communication devices 104 may solicit information and/or an acknowledgement from the user, which may be entered via input device 208.

With reference now to FIG. 3, when a trip to a particular country is desired, the traveler prepares a travel request for submission to the system 100. The travel request may be a travel request form completed by the traveler, for example, through a communication device 104, via intranet 108, or may be in a different format, such as paper form or email. When the travel request is a form, such as shown in the exemplary page of FIGS. 4A-4C, certain information may be required in order to submit the form, while other information is not required. The required travel information, in some embodiments, may be based on the travel destination. In particular, more travel information may be required to travel to the Middle East or South America, for example, as compared to Europe or Canada.

The travel request may include travel information, such as the traveler's name, the travel country, the travel city, and the dates of travel, as shown, for example, in FIGS. 4A-4C. In this example embodiment, drop-down menus in the travel request indicate fields to be completed by the traveler (and may include predefined selection options for each field, where additional options may only be available upon request to the travel organizer). Other fields in the travel request may also be shown to the traveler, but may not be editable by the traveler (e.g., the traveler's title with the company, etc.). Such other fields may only be editable by a travel organizer or other user having sufficient privileges or credentials. Further, the fields available for edit to the traveler may change during the submission and/or approval process of the travel request (e.g., the travel destination may only be editable to the traveler when creating the travel request, and may then be un-editable to the traveler during subsequent approval steps, or different fields may become editable based on information entered in other fields, etc.). In other exemplary embodiments, travel requests may include additional and/or different fields to solicit, from the traveler, information, such as, for example, travel itinerary fields, traveler notes for consideration in reviewing the travel requests, medical conditions, status fields, etc. It should be appreciated that the fields and/or arrangements of the fields may be different than illustrated in the exemplary page of FIGS. 4A-4C. In at least one embodiment, the traveler is permitted to electronically attach information, such as, for example, travel arrangements and/or schedules, travel confirmations, reservations, etc., to the travel request.

Once the travel request is prepared, it is transmitted to and/or received 302 by the server 102, for example, from one of the communication devices 104 or another device. After receiving 302 the travel request, in this embodiment, the server 102 retrieves 304 additional information related to the traveler and/or destination(s). Such additional information retrieved 304 by the server 102, from memory 204, may be associated with a travel profile of the traveler. Specifically, in the exemplary embodiment shown in FIG. 3, the server 102 retrieves 306 a travel profile for the traveler, as part of retrieving 304 additional information. The travel profile may be maintained by the organizer and may include, for example, confirmation of the traveler's name (e.g., confirmation that the traveler is in fact an employee associated with the organizer), the traveler's corporate title, the traveler's corporate department, and any special travel exceptions for the traveler (see FIG. 4A, and the additional information previously described). The additional information, and/or the traveler profile, may further include, for example, additional personnel information, predetermined travel preferences for the traveler, traveler feedback, and travel history for the traveler to the destination and/or other destinations, etc.

Part or all of such additional information may be stored, for example, in memory 204 of the server 102, and/or another memory 204 or multiple memories 204 within the system 100, and accessible to server 102. Additionally, or alternatively, part or all of the additional information may be retrieved from a third party, such as, for example, a risk assessor or travel service, via network 106, or other entity (e.g., other analysts that use open sources, contracted risk management servers, locally based proprietary security specialists, hotel tracking tools, etc.).

The server 102, in the exemplary embodiment, next assigns 308 a risk value to the travel request. The assigned risk value may be based on travel risks at the destination, or a region of the destination, as well as identity of the traveler, etc. The risk value may be provided on a scale, for example, from high risk to low risk, etc. Further, the risk value may be obtained by the server 102, via network 106, from one or more third-parties who routinely, or occasionally, maintain such risk values for multiple destinations. Additionally, or alternatively, the risk value may be independently determined, calculated, etc. by the server 102, for example, based on various factors, such as, for example, travel destination, identity of the traveler, crime statistics, prior travel incidents, destination governmental stability, international reputation, information from other analysts, information from locally based proprietary security specialists, etc. Non-limiting examples of a risk value that may be assigned 308 by the server 102 include a Tier 1 risk value indicating a very high risk (e.g., assigned to an extreme risk destination, etc.), a Tier 2 risk value indicating a high risk (e.g., assigned to an elevated risk location, etc.), and a Tier 3 risk value indicating a moderate risk (e.g., assigned to a lower risk location, etc.). As an example, a Tier 1 risk is associated with the exemplary travel request shown in FIGS. 4A-4C, where the travel destination is Kabul, Afghanistan. It should be appreciated that a different number of risk values may be used by the server 102, and/or may be available to the server 102, to assign to one or more travel requests.

In some embodiments, upon assigning a risk value to the travel request (e.g., a Tier 1 risk value, a risk value higher than a predefined risk value, a risk value higher than a predetermined threshold, etc.), the server 102 then solicits 310, for example, from a travel organizer, approval of the travel request. Such travel organizer may include a supervisor of the traveler, or other person associated with the employment of the traveler or the activities and/or responsibilities of the traveler. The travel organizer may further include one or more individuals associated with the travel destination who have particular insight into traveler risk for the travel destination. Such individuals may be able, in some implementations, to provide an additional insight (in addition to the assigned risk value) into whether the traveler is safe to travel to the destination for the duration of the travel. The same of different types of approvals may be solicited from persons other than the travel organizer, including, for example, the traveler. Additionally, or alternatively, it should be appreciated that the server 102 may solicit one or more approvals (related to the travel request or travel plan, for example) before or after other operations in the method 300. Approvals may involve various criteria, including, without limitation, the associated risk of the destination, the value of the travel, business concerns, company policy, personal circumstances, etc. If a travel request is cancelled for any reason during any of these approvals, the traveler may, in some embodiments, receive a notification such as by email message, text message, etc., indicating the cancelation and one or more reasons the request was cancelled, or no reason the request was cancelled.

With continued reference to FIG. 3, the server 102 next compiles 312 a travel plan. The travel plan includes at least part of the information included in the travel request, and security measures intended to confirm and/or account for the safety of the traveler, during his/her travel.

In the illustrated embodiment, and indicated by the dotted lines, compiling 312 the travel plan optionally includes identifying 314 travel directives for the travel destination and assigning 316 predetermined check-in times. Travel directives may include, for example, suggestions and/or precautions, for behavior in the destination to promote traveler safety, and in some embodiments, explanation(s) of the perceived risks associated with the travel destination, or aspects thereof. Exemplary directives include suggested curfews, suggested modes of transportation, hotel recommendations, etc. The predetermined check-in times are times at which check-in communications are sent to the traveler, thereby prompting the traveler to check-in. Check-in times, as used herein, may include predetermined check-in times and/or may refer to times at which the traveler will be at particular locations, for example, without limitation, times corresponding to a start of the trip, arrival of the traveler at an airport, arrival of the traveler at the location, arrival of the traveler at various destinations at the location, arrival of the traveler at home, etc. As an example, the travel directives and predetermined check-in times for the travel plan associated with travel request of FIGS. 4A-4C are incorporated by the server 102 directly in the travel request page (see FIGS. 4B and 4C).

The travel plan may be automatically compiled 312, by the server 102, based on one or more defaults. In one example, where the risk is Tier 1, the default travel plan may include predetermined check-in times every five hours, with additional predetermined check-in times for arrival and departures from certain places. The travel plan may further be based on numerous inputs from, or modified by, the travel organizer or other user, at one of the communication devices 104. Such inputs and/or modification may account for the risk value, travel destination, traveler identity, traveler profile, or other consideration, etc. In one example, the server 102 may initially identify (e.g., auto-populate in the travel plan, etc.) travel directives from a list of predefined directives for a given destination, and then permit the travel organizer to modify the directives as needed (e.g., as suggested by regional personnel, based on the traveler's profile, etc.). As shown for the exemplary travel request in FIGS. 4A-4C, the travel directives may also be provided in editable format such that the organizer can specifically tailor them as desired (see FIG. 4B).

Similarly, the server 102 may initially assign 316 check-in time(s) for travel based on a default schedule of check-in times associated with, for example, a set of activities typically included in trips, including arrival at airports, arrival at hotels, etc. The check-in times may then be modified, by the travel organizer or other user, as needed, based on, for example, the risk value assigned to the trip, the identity of the traveler, the traveler's profile, etc. Moreover, the travel organizer is able to review and revise the travel plan, manually, to modify it based on any criteria associated with the traveler, destination, etc. Regardless of the inputs and/or modifications provided by the organizer (even if each component of the travel plan is input manually by the organizer), the server 102 compiles 312 the electronic travel plan and stores it in the memory 204. Additionally, in some embodiments, the server 102, automatically, or at prompting from the travel organizer, may also update the travel plan, during the trip, to account for changes in the traveler's itinerary during the trip (e.g., changes in flight times, changes in meetings, etc.). Further, in at least one embodiment, the travel plan may include one or more predetermined check-in locations for the traveler in or around the destination, or as dictated by a travel itinerary.

It should be appreciated that the check-in times included in a travel plan may vary depending on the various aspects of the travel, the individual travelers, and/or the travel destinations. As an example, for a traveler on a trip having a lower-risk value, the travel plan may include only the predefined travel directives and may include only two predetermined check-in times. Alternatively, if the same trip has a higher risk value, the travel plan may include the predefined travel directives for the destination, as well as additional travel directives specific to the destination (e.g., avoid ABC business on 1st Street, etc.), and may then also include the default check-in times, along with multiple additional predetermined check-in times to account for the assigned risk value. The server 102, or travel organizer, may further request particular itinerary information from the traveler (e.g., meeting schedules, meal schedules, hotel schedules, etc.), if not included with the original travel request, in order to further revise the travel plan. As another example, for a traveler who routinely travels with security (e.g., a CEO of a company, etc.) or a traveler who resides in the travel location, the travel plan may include no travel recommendations and/or no predetermined check-in times. In yet further examples, factors, such as traveler experience in the destination, nationality, residence in the destination, travel frequency, etc., may also be considered in assigning check-in times.

It should be appreciated that the travel plan can be tailored to the particular traveler and/or destination, such that a sufficient level of interaction with the traveler is achieved to confirm and/or account for the traveler's safety, but without unnecessarily inconveniencing the traveler. In this manner, methods and systems herein may provide substantial flexibility to account for numerous different travelers, characteristics of the travelers, and travel scenarios, and specifically, their individual security needs.

With further reference to FIG. 3, once the travel plan is compiled 312, the server 102 sends 318 the travel plan (or a part thereof) to the traveler for approval. For example, the server 102 may send an email, via the network 106, to the traveler, with a link provided in the email to the travel request where the traveler can review the travel plan and provide his/her acknowledgement to abide by the travel plan (e.g., the traveler may be required to check a box on the travel request to thereby indicate agreement, acceptance, and/or acknowledgement of the travel plan, etc.). In some aspects, the acknowledgement of the travel plan may also operate to educate the traveler on the travel destination, and any associated risks therewith, prior to start of the travel. In some embodiments, acknowledgement by the traveler may be required prior to approval of the trip (e.g., by the organizer of the travel, etc.), and/or proceeding to other operation.

In addition to the above, the server 102 may limit the time from receipt of the travel request and/or compilation of the travel plan, or other operation, until the start date of the travel. Specifically, for example, when a travel request is for a high risk destination, factors implicating the safety of the traveler may change frequently. If a travel plan is compiled three weeks prior to the travel, subsequent events in the high risk destination may implicate additional travel directives and/or a different frequency of predetermined check-in times. Not only the amount of information in the travel request, and additional information retrieved, but the accuracy of the information on the date of travel affects whether the travel plan is the best for the travel. In one or more preferred embodiments, therefore, for high risk destination, a travel plan may not be compiled more than five, ten, 15 or 20 days, or one month, two months, etc. in advance of the start date of the travel. In other embodiments, the travel plan may be compiled, regardless of the start date of the travel.

In the exemplary embodiment, after the travel plan has been compiled 312, and the travel is approaching or imminent, the server 102 schedules 313 a check-in communication for each predetermined check-in time included in the travel plan. In the exemplary embodiment, check-in communications are often scheduled after approval has been received (when required) and the travel has been confirmed. Here, the travel may be confirmed by the traveler and/or travel organizer to thereby indicate, to the server 102, that the travel is indeed going to happen, and has not been cancelled. The confirmation may be part of an approval, travel request, or other operation associated with receiving the travel request or compiling the travel plan, but is preferred to be close in time to the start date of the travel, to thereby reduce the risk the check-in communications are scheduled for travel which is ultimately cancelled.

When multiple check-in times are included in the travel plan, the check-in communications may be scheduled in parallel or sequentially. In other words, each check-in communication may be scheduled before the trip begins, at the predetermined check-in times, so that the server 102 sends the check-in communication regardless of whether other check-in communications have been acknowledged, as described below. Conversely, when scheduled sequentially, the server 102 does not proceed to the next predetermined check-in time, until an acknowledgment is received for the prior check-in communication. In such embodiments, as described below, reminder and/or other final communications may be sent, by the server 102, which are associated with the un-acknowledged check-in communication.

Referring again to FIG. 3, the server sends 320 the check-in communication, which may include, without limitation, email messages, text messages (e.g., SMS messaging, MMS messaging, TMS messaging, etc.), or other electronic or voice messages, to the communication device 104 associated with the traveler at the predetermined check-in time. The check-in communication may cause the communication device 104 to generate a tone, ring, vibrate, display an indicator, or otherwise visually and/or audibly inform the traveler of the check-in communication. In at least one embodiment, the check-in communication is an automated voice call to a portable communication device associated with the traveler.

The traveler then has a predefined time interval to acknowledge the communication. The time interval may be about one minute, about five minutes, about 10 minutes, about 30 minutes, or another time interval, etc., and time intervals may be different for different check-in communications due to, for example, the predetermined check-in time. In one example, a check-in communication associated with the arrival, via airplane, of the traveler at the destination may have a longer time interval due to frequent delays associated with air travel. Conversely, in another example, check-in communications scheduled for travel into high risk areas for meetings (as compared to the hotel) may have a shorter time interval.

To track the time interval, the server 102 may initiate a timer based on the time interval, or the server 102 may calculate a required response time (e.g., the final check-in time, etc.) by adding the time interval to the predetermined time. In some embodiments, the server 102 may further send the traveler a reminder communication within a reminder interval of the predetermined check-in time Like the time interval, the reminder interval may be of any duration. The reminder may be sent, from the server 102, prior to or after the associated predetermined check-in time. When the reminder is sent prior to the predetermined check-in time, in some embodiments, no response is required of the traveler (e.g., where the traveler is required to respond to a later check-in communication). Conversely, in other embodiments, when the reminder is sent, by the server 102, after the predetermined check-in interval, the reminder may instruct the traveler to respond to the prior check-in communication.

After sending a check-in communication, the server 102 determines 322 if the acknowledgement is or has been received within the predefined time interval. The traveler may acknowledge the check-in communication in a variety of different ways. For example, where the check-in communication is a text message, the traveler may respond via text message to acknowledge the check-in communication. And, where the check-in communication is an email, the traveler may simply reply to the email. In another embodiment, where the check-in communication is an email, the traveler may simply open a link in the email to provide acknowledgement. In other examples, the traveler may initiate a phone call to an automated voice system to provide an acknowledgement. While certain ways of acknowledging the check-in communication may be preferred (e.g., to incorporate with the automated system, or utilize an efficient communication path, such as text messaging, etc.), it should be appreciated that the traveler, based on the type of check-in communication, or not, may acknowledge the check-in communication in any number of different ways. Moreover, in at least one embodiment, where the travel plan includes at least one predetermined check-in location, the communication device 104 associated with the traveler may include a GPS device, and automatically acknowledge the check-in location when the traveler (and the communication device 104) travel to the predetermined location.

If the server 102 receives 322 acknowledgement from the traveler within the time interval of (before or after) the predetermined check-in time, the server 102 completes 324 the check-in communication. The server 102 then determines 326 if all check-in communications in the travel plan have been acknowledged. And, if the check-in communication is the final communication in the travel plan, or the total number of completed check-in communications equals the number of check-in communications in the travel plan, the server 102 further completes 328 the trip (e.g., closes the travel request, etc.). Conversely, if additional check-in communications are pending, the server 102 continues in executing the travel plan.

Conversely, if the server 102 does not receive 322 acknowledgement from the traveler within the time interval, the server sets 330 a warning event. The particular action taken by the server 102 when the warning event is set, in various embodiments, is dictated by the severity of the missed check-in communication or overdue acknowledgement, taking into account, for example, the number of unresolved missed check-in communications for the travel, the identity of the traveler, the travel destination, etc. Such actions to notify the travel organizer, traveler, or other person may range from minor (e.g., sending, via the server 102, a communication to the traveler indicating that the traveler has not acknowledged a prior check-in communication and giving the traveler an extended time interval to acknowledge, sending a communication to the organizer, sending an alert to one or more communication devices associated with the organizer, such as pop-up or message on a status page, etc.) to more extreme (e.g., sending, via the server 102, a warning communication to security or regional personnel who may then attempt to contact the traveler, in person, electronically, and/or by notifying local authorities, etc.). In one particular example, the action may include sending an email message, by the server 102, to the organizer to notify the organizer of the warning event. In one example, the email message may be titled “Notification of Late IMOK Check-In”, and may include a message such as “Dear Organizer, The following High Risk Travel IMOK check-in requirement is late. Check-In Number: 5888. Check-In Required By: MM/DD/YYYY 12:00:00 PM (Central Standard Time). Check-In Required By: MM/DD/YYYY 8:00:00 PM (Eastern European Time). Traveler: Williams, Bill (e333333). Country: Egypt. City: Cairo. Arrival: MM/DD/YYYY 12:20:00 AM (Central Standard Time). Arrival: MM/DD/YYYY 8:20:00 AM (Eastern European Time). Departure: 11/28/2013 1:25:00 PM (Central Standard Time). Departure: MM/DD/YYYY 9:25:00 PM (Eastern European Time).” It should be appreciated that the particular action may be any appropriate action given the relevant facts to the missed check-in communication.

As represented by the dotted line around operations 320n, 322n, 324n, 330n in FIG. 3, in this embodiment the above processes are repeated by the server 102 for each scheduled check-in communication of the travel plan. It should be appreciated that, as explained above, any number of check-in communications may be included in a travel plan. For each additional predetermined check-in time, scheduled for travel, duplicates of the above operations are included, with each operating substantially the same.

As an illustrative example, the following describes exemplary check-in operations for a travel plan having two predetermined check-in times, one at 1:00 PM on Day 1 of a trip and another at 8:00 AM on Day 2 of the trip. In this example, at 1:00 PM on Day 1, a server sends the traveler a first check-in communication. Here, the check-in communication includes an email message containing a secure link, to which the traveler can acknowledge by opening the link on his/her portable communication device. In some aspects, the link may open the travel request for the traveler and allow the traveler to view status of all check-in communications for the trip, and acknowledge a pending check-in communication or a missed/overdue check-in communication. Alternatively, or additionally, the email message may include a check-in number which would allow the user to call the server and enter the check-in number to thereby provide acknowledgement. In other embodiments, simply opening a link in the email provides sufficient acknowledgement of the check-in communication.

In any case, upon sending the first check-in communication, the server also sets a time interval of, for example, four hours in which to receive the traveler's acknowledgement. As previously described, if the server receives the acknowledgement within the time interval, it will complete the first check-in communication. However, at 5:00 PM on Day 1, if the server has not yet received acknowledgement of the first check-in communication, it will send the traveler a warning communication indicating that the traveler missed the first check-in communication. The server will also provide the traveler with an additional time interval of, for example, four additional hours to provide the acknowledgement, or a different shorter or longer interval associated with reminders and/or warning communications (this may repeat for each missed communication). At 9:00 PM on Day 1, if the server still has not received acknowledgement of the first check-in communication, it will send yet another warning communication to the traveler, and either repeat doing so until acknowledgement is received, or take more invasive action, such as contacting security personnel of the organizer who will then attempt to call, locate, etc. the traveler. At 8:00 AM on Day 2, the server sends the traveler a second check-in communication (again, an email message containing a secure link), regardless of whether the response to the first check-in communication has been received. And, the server again sets a time interval of, for example, four hours in which to receive the traveler's acknowledgement of the second check-in communication. Then, if at 10:00 AM on Day 2, in this example, the server receives acknowledgement of the second check-in communication, it will complete both the first and second check-in communications, and terminate the warning communications associated with the first check-in communication.

In this example, the check-in communications are handled by the server 102 in parallel or independently of each other. The server 102 sends check-in communications at predetermined check-in times (as shown in FIG. 3, for example) regardless of whether earlier check-in communications have been completed. Also in this example, upon receiving acknowledgement of check-in communications, the server completes all uncompleted prior check-in communications. In other embodiments, however, check-in communications may be dependent upon each other, such that the server 102 only sends check-in communications at subsequent check-in times if the earlier check-in communications are complete. In addition, in other exemplary embodiments the server 102 may only close check-in communications upon receipt of acknowledgement for the particular check-in communications (taking this approach in the example above, the first check-in communication, and the associated warning communiation, would remain open until the traveler actually acknowledged the first check-in communication).

In addition to, or as part of, the method illustrated in FIG. 3, the server 102 stores and manages information associated with the method 300. Specifically, for example, the server 102 stores travel requests, travel plans, and traveler profiles in memory 204, and also facilitates the travel requests by sending pages, such as shown in FIG. 4A-C to travelers.

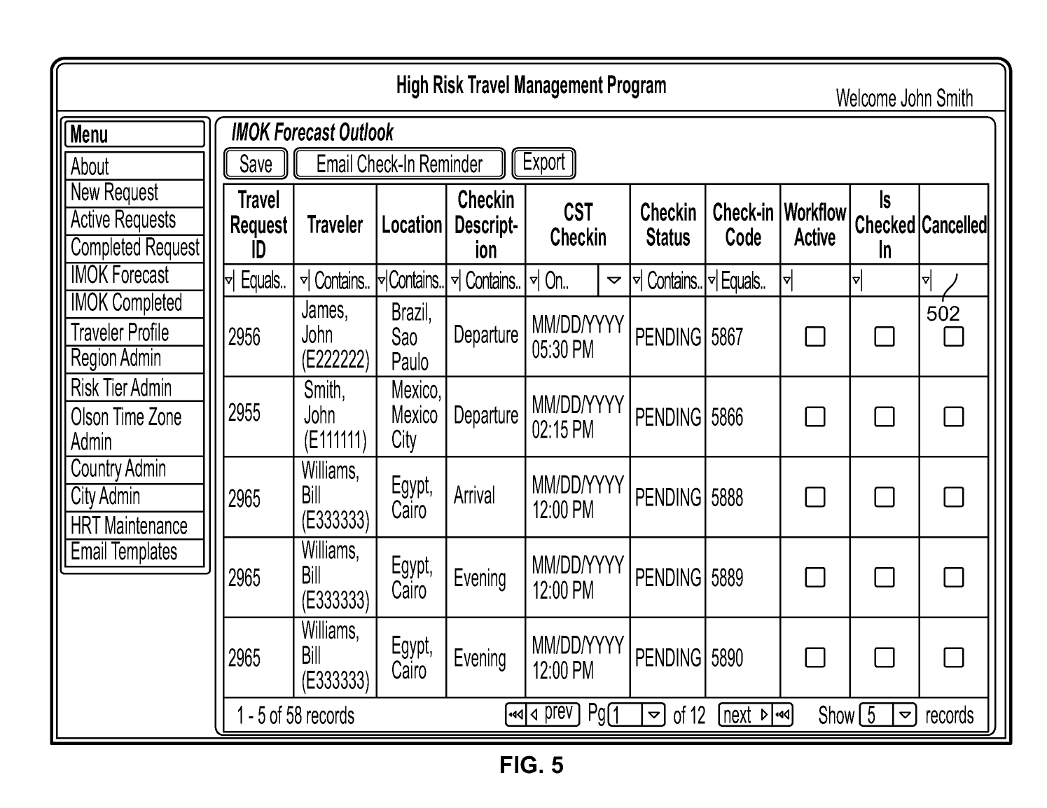

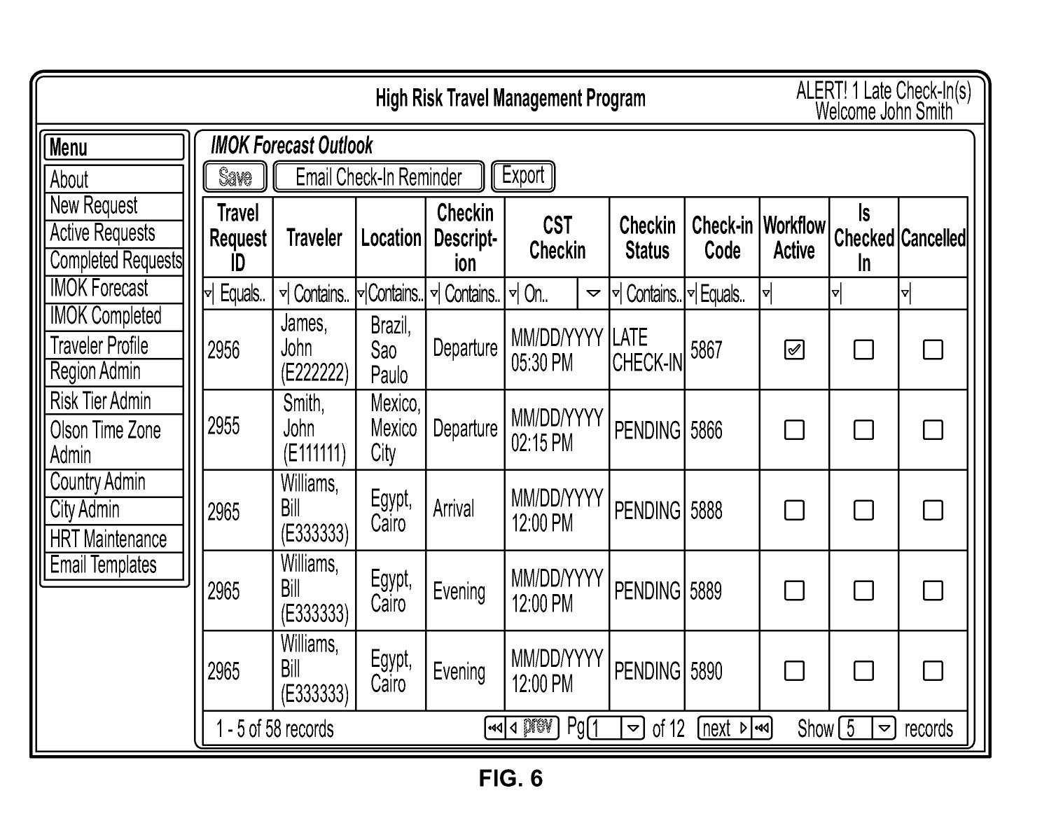

Moreover, the server 102 permits the travel organizer, at one or more pages delivered to a communication device (or directly to server 102, at a display device 206), to review and/or modify travel requests, travel plans, traveler profiles, and scheduled check-in communications (by traveler or by group of travelers), other communications, and warning events. As shown, for example, in FIGS. 5 and 6, multiple check-in communications for multiple travelers can be reviewed in a single scrolling or progressive status page, together in real time. In addition, warning events can immediately be viewed, as they occur, on the status page (compare FIG. 5 and FIG. 6), so that appropriate action can be taken. Through these pages, not only can the number of warning events be tracked (e.g., as a heads-up display at the top of the page), but the particular travelers triggering the warning events can be identified (e.g., in the grid-view via the check-mark).

The server 102 stores the above travel requests and travel plans in a database in memory 204, such that pages indicative of submitted travel requests, approved travel requests, cancelled travel requests, active travel requests (e.g., travel requests for trips where travelers are at the travel locations, etc.), and completed travel requests may be viewed in one or more status pages. The data may be displayed in a variety of different status pages to a travel organizer at a communication device 104, including the exemplary status page of FIG. 5. As shown, the status page may include names of the travelers, their travel destinations and dates, check-in communications and/or predetermined check-in times for each travel plan and/or traveler (see FIG. 5). In addition, in this exemplary embodiment, the status page may be searchable (at 502) to show particular information of interest, from the database, to the travel organizer (e.g., next pending check-in times, etc.). In some embodiments, travel requests or travel plans (such as shown in FIGS. 4A-C) may be viewed by selection or input to a status page include a link to the travel request or travel plan.

Further, one or more status pages may include multiple travel requests for multiple travelers associated with a travel organizer. In some embodiments, a status page includes a listing of check-in communications, listed in order of next in time for all of the ongoing travel for the organization, for example, all pending check-in communications (e.g., a forecast outlook of such communications, etc.), all completed check-in communications, and all missed check-in communications. In some embodiments, the included information specific to individual travelers may be viewed by the travelers, for example, through the travel request.

As shown in FIG. 5, the predetermined check-in times may be included in the status page as a normalized time zone, such as Central Standard Time (CST). In this exemplary embodiment, the server 102 converts the predetermined check-in times from the local time of the communications (in the time zone of the travel destination) to a common reference time. Different reference times may be used in other embodiments, such as, for example, global standard time. In this manner, the travel organizer reviewing and/or managing the travel is able to view impending check-in communications relative to one another. For example, if one traveler is in Argentina, and another traveler is in India, it is difficult to immediately perceive when the check-in communications would be sent, if the check-in times were displayed in local destination time. It is preferred to list the check-in times in a standard time to avoid manual conversion, by the travel organizer, of times at the destinations. The common reference time, therefore, permits the travel organizer to better compare and plan for the impending check-in communications.

When the server 102 initially receives a travel request from a traveler, it stores the travel request in memory 204. As the travel request is subjected to the operation described herein, the server 102 designates the travel request accordingly. For example, when a travel request is cancelled, the server 102 designates it cancelled, whereby it would be included in a status page of cancelled travel requests. Alternatively, when a travel request is approved, the server 102 designates the travel request approved, whereby it would be included in a status page of approved travel requests (e.g., requests that are pending, requests that are planned to start at some future date, etc.). In various embodiments, the servers 102 applies similar designations upon complete operations herein (e.g., approved, scheduled, pending, active, completed, missed, warning, etc.) to the travel requests, travel plans, and individual check-in communications in the database to permit the information to be included in one or more status pages to the travel organizer.

Referring again to FIG. 5, the status page, from the server 102, permits the travel organizer to review any of the above databases in a variety of different ways. It should be appreciated that different pages, including different lists and/or other information may be included in other status pages, from the server 102.

The systems and methods described herein provide travel organizers with the ability to manage (e.g., initiate, schedule, update, oversee, monitor, track, etc.) travel for travelers, particularly higher-risk travel where the travelers may be exposed to greater risks during travel. The systems and methods herein may further provide review and/or approval processes for the travelers to ensure accuracy of their travel information, as well as to acknowledge travel directives for the traveler (and, in effect, provide the travelers with a view of the possible risks associated with the travel and the organizer's participation in their travel). In addition, the systems and methods herein allow for monitoring safety status of the travelers through automated tracking of check-in communications. This, in turn, allows for accurate and quick responses if needed, for example, for missed check-in communications, etc. Further, the systems and methods herein may permit easy and accurate scheduling and monitoring of travel through automatic listings (and automated creation of desired data sets) of current travel and travelers, their check-in times, their check-in status, and their risk areas (e.g., an active directory of travel, etc.).

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) assigning a risk value to a request for travel to at least one destination during a travel period, (b) creating a travel plan based on the assigned risk value, (c) sending a first check-in communication to a traveler at the first predetermined check-in time, (d) designating the first check-in communication completed, when the first check-in communication is acknowledged by the traveler within a time interval the first predetermined check-in time, (e) generating a warning event, when the first check-in communication is not acknowledged by the traveler within the time interval, after the first predetermined check-in time, (f) sending a reminder communication to the traveler within a reminder time interval of the first predetermined check-in time, (g) soliciting approval for the travel request from a traveler organizer, when the assigned risk value is above a predetermined threshold, and (h) receiving approval from the travel organizer for the travel request.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” or “coupled to” another element, it may be directly on, connected or coupled to the other element, or intervening elements may be present. In contrast, when an element is referred to as being “directly on,” “directly connected to,” or “directly coupled to” another element, there may be no intervening elements present. As used herein, the term “and/or” includes any and all combinations of one or more of the associated listed items.

Although the terms first, second, third, etc. may be used herein to describe various events that may be included in a travel plan. These terms may only be used to distinguish one element from another. Terms such as “first,” “second,” and other numerical terms when used herein do not imply a sequence or order unless clearly indicated by the context. Thus, a first check-in communication, or first predetermined time, described and claimed herein, could be termed a second check-in communication or second predetermined time without departing from the teachings of the example embodiments.

What is claimed is:

1. A computer-implemented method for use in managing travel, the method comprising:
assigning a risk value to a request for travel to a destination;
compiling a travel plan based on the assigned risk value, the travel plan defining a first predetermined check-in time during a travel period;
sending a first check-in communication, via a network interface, to a traveler at the first predetermined check-in time;
designating the first check-in communication completed, when the first check-in communication is acknowledged by the traveler within a time interval of the first predetermined check-in time; and
generating a warning event, when the first check-in communication is not acknowledged by the traveler within the time interval of the first predetermined check-in time.

2. The method of claim 1, wherein the travel plan is further based on a profile associated with the traveler, and wherein the risk value assigned to the request is based on the destination.

3. The method of claim 1, wherein the travel plan includes a second predetermined check-in time during the travel period, the method further comprising:
sending a second check-in communication to the traveler at the second predetermined check-in time;
designating the second check-in communication completed, when the second check-in communication is acknowledged by the traveler, via the network interface, within the time interval after the second predetermined check-in time; and
generating a warning event, when the second check-in communication is not acknowledged by the traveler within the time interval of the second predetermined check-in time.

4. The method of claim 1, further comprising sending a reminder communication to the traveler, via the network interface, prior to the first predetermined check-in time.

5. The method of claim 1, wherein the travel plan further includes at least one travel directive, the at least one travel directive instructing at least one behavior of the traveler during the travel period; the method further comprising:
transmitting the at least one travel directive to the traveler for display at a communication device associated with the traveler; and
receiving a response from the traveler, via the network interface, indicating the traveler accepts the at least one travel directive, prior to sending the first check-in communication.

6. The method of claim 5, further comprising soliciting, via the network interface, approval for the travel plan from a traveler organizer, when the assigned risk value is above a predetermined threshold and receiving, via the network interface, approval from the travel organizer for the travel plan; and
wherein sending the first check-in communication includes sending the first check-in communication after the travel plan has been approved by the traveler organizer.

7. The method of claim 1, wherein the travel plan further includes at least one travel directive based on the destination, the method further comprising:
transmitting the at least one travel directive to the traveler for display at a communication device associated with the traveler; and
receiving agreement to the at least one travel directive, prior to sending the first check-in communication.

8. The method of claim 1, wherein generating the warning event comprises setting the warning event and sending an email message, via the network interface, to a travel organizer, the email message indicating the warning event.

9. A travel management system for use by a travel organizer, the system comprising:
a memory; and
a processor coupled to the memory, the processor configured to compile a travel plan based on a travel request received into the memory, the travel plan including an identity of a traveler, a destination, and at least one predetermined check-in time;
the processor configured to schedule and send a check-in communication for each of the at least one predetermined check-in time, the check-in communication including a request for acknowledgement from the traveler;
the processor configured to check for a traveler acknowledgement for up to a time interval after each of the at least one predetermined check-in time; and when the traveler acknowledgement is not received within the time interval, the processor is configured to set and store in memory a warning event associated with the travel plan, and notify the travel organizer of the warning event.

10. The system of claim 9, wherein the processor is configured to compile the travel plan, based on a risk assigned to the travel request.

11. The system of claim 9, wherein the processor is further configured to transmit, to one or more communication devices, a status page including the at least one predetermined check-in time and an identity of the traveler for the at least one predetermined check-in time.

12. The system of claim 11, wherein the processor is further configured to convert the at least one predetermined check-in time from a time in a time zone at the destination to a common reference time; and
wherein the status page includes the predetermined check-in time in the common reference time.

13. The system of claim 9, wherein the memory is configured to store default predetermined check-in times for multiple risk values; and
wherein the processor is configured to assign one of the multiple risk values to the travel request and compile the travel plan based on the default predetermined check-in times associated with the assigned risk value.

14. The system of claim 13, wherein the memory is configured to store predefined travel directives associated with multiple destinations including said destination; and
wherein the processor is further configured to include at least one of the predefined travel directives, associated with said destination, in the travel plan to compile the travel plan.

15. The system of claim 9, wherein the processor is further configured to cause to be displayed, at a communication device, a travel request page including a travel request form having multiple fields for soliciting travel information from a traveler and a button to submit the travel request form.

16. The system of claim 9, wherein the memory is configured to store multiple traveler profiles; and
wherein the processor is further configured to compile the travel plan based on a select one of the traveler profiles associated with said traveler.

17. The system of claim 16, wherein the at least one predetermined check-in time includes multiple check-in times; and
wherein the processor is configured to schedule and send check-in communications for each of the multiple check-in times regardless of whether acknowledgement is received for any other of the multiple check-in communications.

18. One or more non-transitory computer readable media having computer-executable instructions embodied thereon, wherein when executed by a processor, the computer-executable instructions cause the processor to:
assign a risk value to a request for travel to at least one destination;
create a travel plan for the travel, based on the assigned risk value, the travel plan defining multiple predetermined check-in times;
for each of the predetermined check-in times,
send a check-in communication to a traveler at the predetermined check-in time;
designate the check-in communication completed, when the check-in communication is acknowledged by the traveler within a time interval of the predetermined check-in time; and
set a warning event and notify a travel organizer, when the check-in communication is not acknowledged by the traveler within the time interval of the predetermined check-in time.

19. The one or more non-transitory computer readable media of claim 18, wherein when executed by the processor, the computer-executable instructions further cause the processor to display, at one or more communication devices, a status page including at least one of the multiple predetermined check-in times.

20. The one or more non-transitory computer readable media of claim 18, wherein, for each of the predetermined check-in times, the computer-executable instructions cause the processor to cause to be displayed, at one or more communication device, an alert associated with the warning event to notify a travel organizer.
